(19) United States
(12) Patent Application Publication
(10) Pub. No.: US 2016/0316817 A1
(43) Pub. Date: Nov. 3, 2016

(54) ELECTRONIC CIGARETTE

(71) Applicant: Qiuming LIU, Guangdong (CN)

(72) Inventor: Qiuming LIU, Guangdong (CN)

(21) Appl. No.: 14/118,773

(22) PCT Filed: Sep. 3, 2013
(86) PCT No.: PCT/CN2013/082844

§ 371 Date: Nov. 19, 2013

(30) Foreign Application Priority Data
Aug. 14, 2013 (CN) 201320496679.9

(51) Int. Cl. A24F 47/00; F16L 37/088

(52) U.S. Cl. CPC A24F 47/008; F16L 37/088

(57) ABSTRACT

There is provided in the present application an electronic cigarette, including a block provided on an atomizer outer electrode and a slot provided on a battery rod outer electrode, with a positioning member for positioning the block being provided in the slot. In the electronic cigarette according to the present application, the positioning member is provided in the slot of a battery rod electrode such that, after the block of an atomizer electrode enters in the slot, the positioning member exerts a force on the block to position the block, thereby avoiding a return rotation of the atomizer, further avoiding a looseness and separation between the atomizer and the battery rod, and bringing a better usage experience to users.

This application claims is the US national phase of International Application No. PCT/CN2013/082844 filed on Sep. 3, 2013, which the benefit of priority to Chinese patent application No. 201320496679.9 titled “ELECTRONIC CIGARETTE” and filed with the Chinese State Intellectual Property Office on Aug. 14, 2013, the entire disclosure of which is incorporated herein by reference.

### FIELD OF THE INVENTION

The present application relates to the technical field of fittings of the electronic cigarette, and more specifically, to an electronic cigarette.

### BACKGROUND OF THE INVENTION

An electronic cigarette is a common emulation electronic product of cigarette, which mainly includes liquid storage cotton, an atomizer and a battery. The battery supplies electricity to the atomizer, which makes the atomizer heated, so that the liquid stored in the liquid storage cotton is vaporized to release smoke, thereby achieving an effect of emulation cigarette.

An electronic cigarette generally includes two parts of an atomizer 01 and a battery rod 02, as shown in FIGS. 1 to 3. An atomization device and liquid storage cotton are fitted in the atomizer 01, and the battery rod 02 is provided with a battery. The atomizer 01 and the battery rod 02 are connected and electrically conducted with each other by bayonet-mounting electrode assemblies provided on respective connecting ends thereof The electrode assembly includes an annular outer electrode and a rod-shaped inner electrode which are provided on the corresponding one of the atomizer 01 and the battery rod 02, and the outer electrode and the inner electrode are insulated with each other by an insulating ring 03 provided on the corresponding one of the atomizer 01 and the battery rod 02. When the atomizer 01 is connected to the battery rod 02, the two outer electrodes are interconnected and conducted with each other, and the two inner electrodes are mutually contacted and conducted with each other. One or more blocks 05 are provided on the outside circumference surface of the atomizer outer electrode 04, and a guide groove 07 for permitting the block 05 to enter and slide therein is provided in the inside circumference surface of the battery rod outer electrode 06. The guide groove 07 extends along the axis direction of the battery rod 02, and a slot 08 is provided at the deep end of the guide groove 07 and communicates with the guide groove 07. The slot 08 extends along the circumference direction of the battery rod 02.

A connecting process between the atomizer 01 and the battery rod 02 includes: aligning the connecting ends of the atomizer 01 and the battery rod 02, inserting the block 05 into the corresponding guide groove 07 and going deeper until the block 05 entirely passes through the guide groove 07, rotating the atomizer 01, so that the block 05 is screwed in the slot 08 and is not in a line with the guide groove 07, thereby avoiding the block 05 from sliding reversely out of the guide groove 07, and engaging the atomizer 01 with the battery rod 02 by the block 5.

However, when the electric cigarette with the structure mentioned above is in actual practice, a return rotation frequently occurs to the atomizer 01 connected to the battery rod 02 because of a vibration applied to the electronic cigarette at the time of transportation or usage. When the block 05 returns to the guide groove 07 from the slot 08, the block 05 is prone to slide out of the guide groove 07, which leads to a looseness and separation between the atomizer 01 and the battery rod 02, and causes an inconvenience and a bad experience to a user in a normal use.

Thus, a problem to be solved presently by those skilled in the art is to avoid a return rotation of the atomizer.

### SUMMARY OF THE INVENTION

In view of this, there is provided in the present application an electronic cigarette which could avoid a return rotation of the atomizer, and thereby further avoid a looseness and separation between the atomizer and the battery rod.

In order to achieve the above object, following technical solutions are provided in the present application.

An electronic cigarette includes a block provided on an atomizer outer electrode and a slot provided on a battery rod outer electrode, with a positioning member for positioning the block being provided in the slot.

Preferably, in the electronic cigarette, the positioning member is an elastic member capable of exerting a pressing force on a plurality of the blocks simultaneously.

Preferably, in the electronic cigarette, elastic connection sections for exerting a pressing force on the blocks are flat elastic plates located on both sides of an opening of the U-shaped elastic member.

Preferably, in the electronic cigarette, elastic connection sections for exerting a pressing force on the blocks are arc elastic plates located on both sides of an opening of the U-shaped elastic member, and the arc elastic plates are convex towards an axis of the battery rod outer electrode.

Preferably, in the electronic cigarette, the U-shaped elastic member is an elastic metal wire. Elastic connection sections of the elastic metal wire for exerting a pressing force on the blocks are arc-shaped sections located on both sides of an opening of the U-shaped elastic member, and the arc-shaped sections are convex towards an axis of the battery rod outer electrode.

Preferably, in the electronic cigarette, the positioning member is an elastic stopper which is able to stretch into the slot, and the elastic stopper is provided on an insulating ring of the electronic cigarette.

Preferably, in the electronic cigarette, there are a plurality of the elastic stoppers capable of blocking and positioning a plurality of the blocks simultaneously.

In the electronic cigarette according to the present application, the positioning member is provided in the slot of a battery rod electrode such that, after the block of an atomizer electrode enters in the slot, the positioning member exerts a force on the block to position the block, thereby avoiding a return rotation of the atomizer, further avoiding a looseness and separation between the atomizer and the battery rod, and bringing a better usage experience to users.

### BRIEF DESCRIPTION OF THE DRAWINGS

In order to more clearly illustrate embodiments of the present application or technical solutions in the prior art, drawings required for the description of the embodiments or the prior art will be briefly introduced below. Apparently, the drawings described below simply relate to some embodiments of the present application, and those skilled in the art may obtain other drawings, based on the following drawings, without any creative work

FIG. 1 is a structural schematic view of an electronic cigarette in the prior art;

FIG. 2 is a structural schematic view of an atomizer;

FIG. 3 is a structural schematic view of a battery rod;

FIG. 4 is a structural schematic view of an electronic cigarette according to an embodiment of the present application;

FIG. 5 is a partial enlarged view of FIG. 4;

FIG. 6 is a structural schematic view of a battery rod;

FIG. 7 is a partial enlarged view of FIG. 6;

FIG. 8 is an assembly view of a battery rod outer electrode, a positioning member and an insulating ring;

FIG. 9 is a structural schematic view of a positioning member in which the elastic connection section is flat elastic plates;

FIG. 10 is a structural schematic view of a positioning member in which the elastic connection section is arc elastic plates;

FIG. 11 is a structural schematic view of the elastic metal wire;

FIG. 12 is an assembly view of a battery rod outer electrode, an insulating ring and an elastic stopper; and

FIG. 13 is a structural schematic view of an insulating ring;

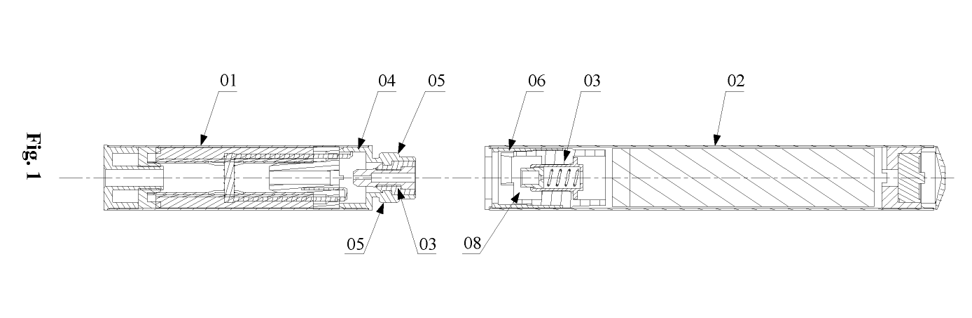

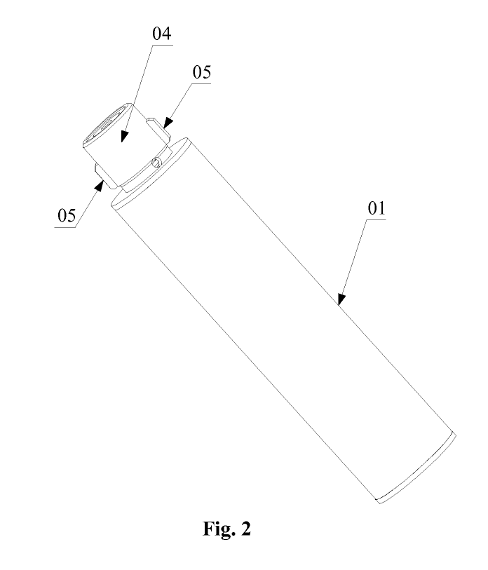

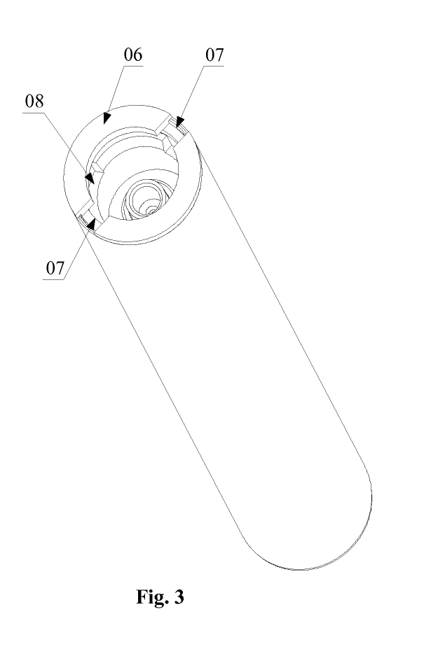

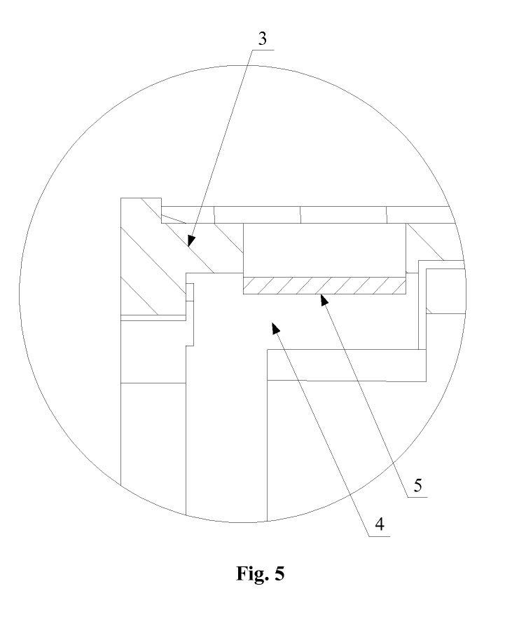

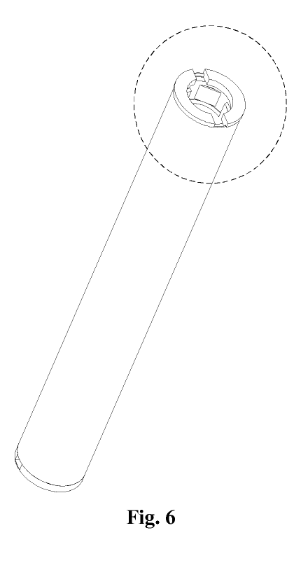

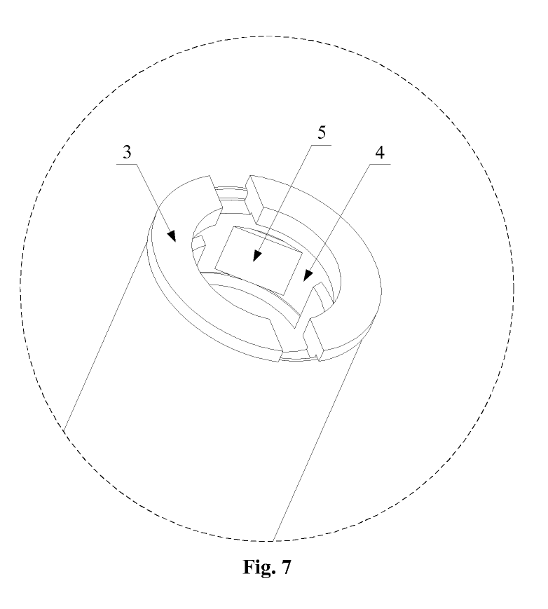

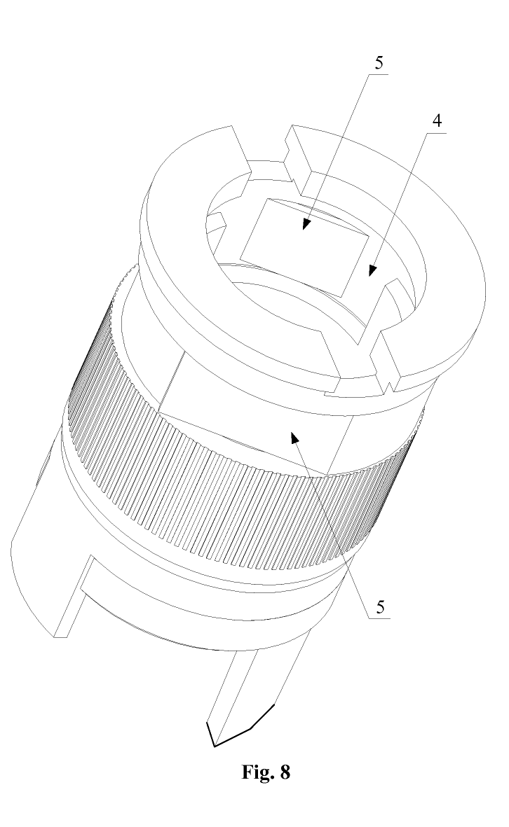

Reference numerals in FIGS. 1 to 13:

Atomizer 01, battery rod 02, insulating ring 03, atomizer outer electrode 04, block 05, battery rod outer electrode 06, guide groove 07, slot 08;

atomizer outer electrode 1, block 2, battery rod outer electrode 3, slot 4, positioning member 5, insulating ring 6, elastic stopper 7, elastic connection section 501.

### DETAILED DESCRIPTION

There is provided in the present application an electronic cigarette which could avoid a return rotation of the atomizer, and thereby further avoid a looseness and separation between the atomizer and the battery rod.

Hereinafter, in conjunction with the drawings in embodiments of the present application, technical solutions in the embodiments of the present application will be described clearly and fully. Apparently, the embodiments described below are simply a part of, not all of embodiments of the present application. Based on the embodiments described herein, other embodiments obtained by those skilled in the art without any creative work also are deemed to fall within the protection scope of the present application.

Two block 2, two guide groove and two slot 4 are taken as example herein to illustrate the technical solutions, and should not be considered as an absolute limitation to protection scope. The number of the block 2, the guide groove and the slot 4 could also be varied.

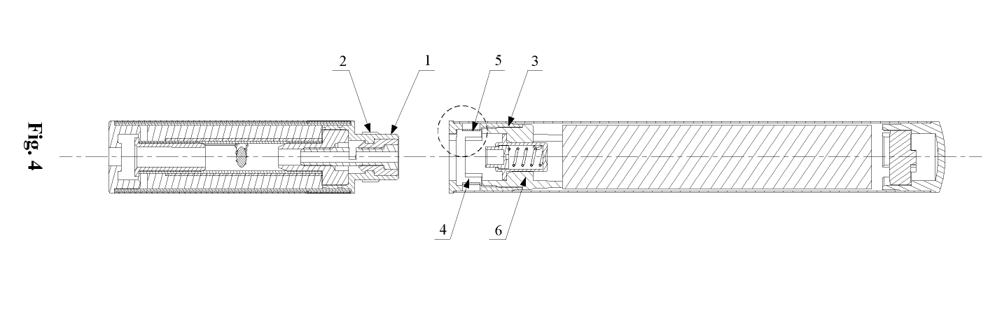

As shown in FIGS. 4 to 13, the electronic cigarette according to an embodiment of the present application includes a block 2 provided on an atomizer outer electrode 1 and a slot 4 provided on a battery rod outer electrode 3. A positioning member 5 for positioning the block 2 is provided in the slot 4. The number of the block 2 may be one or more, and the number of the slot 4 and the number of the block 2 are in one-to-one correspondence.

In the electronic cigarette according to the present embodiment, the positioning member 5 is provided in the slot 4 of a battery rod electrode such that, after the block 2 of an atomizer electrode enters in the slot 4, the positioning member 5 exerts a force on the block 2 to position the block 2, thereby avoiding a return rotation of the atomizer, further avoiding a looseness and separation between the atomizer and the battery rod, and bringing a better usage experience to users.

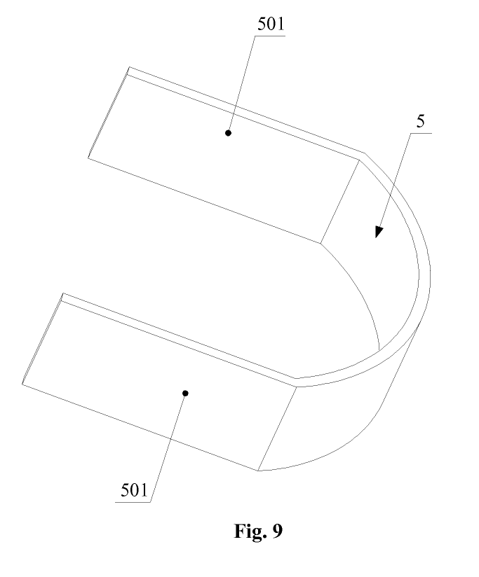

In order to further optimize the technical solution mentioned above, in the electronic cigarette according to the present embodiment, the positioning member 5 is specifically a U-shaped elastic member which may exert a pressing force on a plurality of the blocks 2 simultaneously. A distance between two elastic connection sections 501 of the U-shaped elastic member is less than the distance between outer edges of the two blocks 2 provided on the atomizer outer electrode 1. As such, when two blocks 2 is inserted into a inner space surrounded by the U-shaped elastic member and is rotated, the distance between the two elastic connection sections 501 is enlarged, so that the U-shaped elastic member is deformed and the elastic connection sections 501 exerts a pressing force on the blocks 2, as shown in FIGS. 9 to 13. In the present embodiment, an elastic member which is able to exert a pressing force on the block 2 is chosen as the positioning member 5 for clamping and positioning the block 2. Moreover, for the sake of simplifying the structure of the elastic member, avoiding the influence on the other components of the electronic cigarette, and pressing and clamping a plurality of the blocks 2 tightly at the same time, it is preferable in the present embodiment that the elastic member is in a U-shape with a plurality of the elastic connection sections 501, which may reduce a difficulty in processing and mounting while meeting the above requirements.

In addition, there are two blocks 2 in this embodiment, and the elastic connection sections 501 exerting a pressing force on the blocks 2 are parts located at two sides of the opening of the U-shaped elastic member. When the number of the blocks 2 is any other value, the elastic connection sections 501 exerting a pressing force on the blocks 2 may also be other parts of the U-shaped elastic member, and moreover, the number and the location of the elastic connection sections 501 are in one-to-one correspondence with that of the blocks 2. Certainly, the positioning member 5 is not simply limited to the elastic member, and may also be any other blocking structure capable of meeting working requirements.

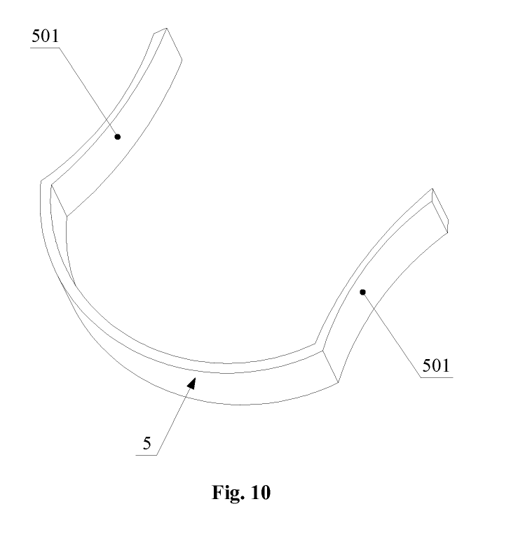

In this embodiment, the positioning member 5 and the elastic connection section 501 may be of a variety of different structures. For example, the positioning member 5 appears in U-shape as a whole, and the elastic connection sections 501 are located at two sides of its U-shaped opening and are flat elastic plates, as shown in FIG. 9. As shown in FIG. 10, the elastic connection section 501 also may be an arc elastic plate being convex towards the axis of the battery rod outer electrode 3, such that a larger deformation of the U-shaped elastic member is produced when the block 2 rotates and presses the U-shaped elastic member, and thus a larger pressing force is exerted to the block 2 by the U-shaped elastic member, so as to further improve the effect of positioning the block 2.

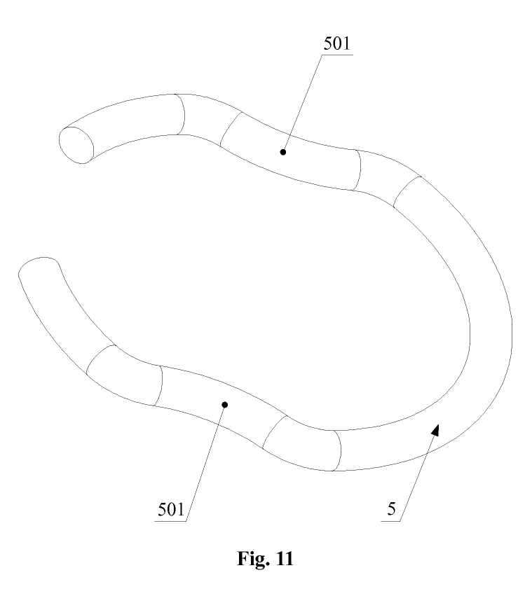

Besides the U-shaped elastic plate, an elastic metal wire with elasticity may be shaped into a U-shaped structure and may also be used as the positioning member 5. The elastic metal wire could function to compress and position the block 2 similarly, and the elastic connection sections 501 of the elastic metal wire exerting a pressing force on the blocks 2 are arc-shaped sections located on both sides of the U-shaped opening, with the arc-shaped sections curving towards the axis of the battery rod outer electrode 3, as shown in FIG. 11.

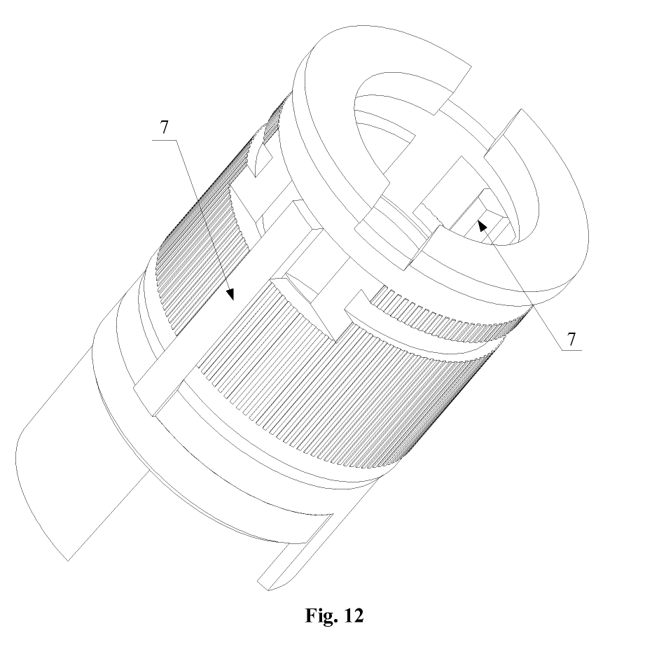

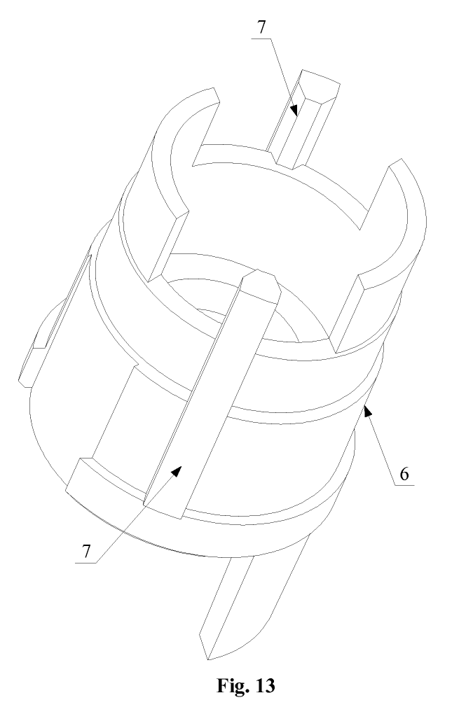

Further, besides the positioning manner in which the positioning member 5 is provided in the slot 4 to clamp and position the block 2, another positioning manner is also provided in this embodiment, in which an elastic stopper 7 is provided on the insulating ring 6 for insulating the battery rod outer electrode 3 from a battery rod inner electrode. Similarly, the number and position of the elastic stopper 7 are in one-to-one correspondence with the number and position of the block 2, the guide groove and the slot 4, as shown in FIGS. 12 and 13. Since the insulating ring 6 is provided inside the battery rod outer electrode 3, the elastic stopper 7 could be provided on the top of the insulating ring 6, and extend deep into the slot 4 so as to block the rotation of the block 2. When the block 2 enters in the slot 4 and is rotated, a larger force needs to be applied to deform the elastic stopper 7, that is, the block 2 overcomes the blocking by the elastic stopper 7 and is rotated in place. At this time, the elastic stopper 7 lies in the return rotation path of the block 2, and thus block the return rotation of the block 2, which could better prevent the looseness and separation between the atomizer and the battery rod as well.

The embodiments of the present description have been described in progressive manner, focusing on illustrating differences from one another. Identical and similar parts between the embodiments may be referred to mutually.

The foregoing description of the embodiments disclosed enables those skilled in the art to implement or use the present application. Various modifications to these embodiments may be apparent to those skilled in the art, and the general principle defined in the present application could be implemented in other embodiments without departing from the spirit or the scope of the present application. Therefore, the present application will not be limited to the embodiments shown in the present application, but conforms to a broadest scope consistent with the principle and novel features disclosed herein.

1. An electronic cigarette, comprising a block provided on an atomizer outer electrode and a slot provided in a battery rod outer electrode, wherein a positioning member for positioning the block is provided in the slot.

2. The electronic cigarette according to claim 1, wherein the positioning member is an elastic member capable of exerting a pressing force on a plurality of the blocks simultaneously.

3. The electronic cigarette according to claim 8, wherein elastic connection sections for exerting a pressing force on the blocks are flat elastic plates located on both sides of an opening of the U-shaped elastic member.

4. The electronic cigarette according to claim 8, wherein elastic connection sections for exerting a pressing force on the blocks are arc elastic plates located on both sides of an opening of the U-shaped elastic member, and the arc elastic plates are convex towards an axis of the battery rod outer electrode.

5. The electronic cigarette according to claim 8, wherein the U-shaped elastic member is an elastic metal wire, elastic connection sections of the elastic metal wire for exerting a pressing force on the blocks are arc-shaped sections located on both sides of an opening of the U-shaped elastic member, and the arc-shaped sections are convex towards an axis of the battery rod outer electrode.

6. The electronic cigarette according to claim 1, wherein the positioning member is an elastic stopper which is able to stretch into the slot, and the elastic stopper is provided on an insulating ring of the electronic cigarette.

7. The electronic cigarette according to claim 6, wherein there are a plurality of the elastic stoppers capable of blocking and positioning a plurality of the blocks simultaneously.

8. The electronic cigarette according to claim 2, wherein the elastic member is a U-shaped elastic member.
